(19) United States
(12) Patent Application Publication
(10) Pub. No.: US 2026/0304289 A1
(43) Pub. Date: Oct. 1, 2026

(54) PROVISIONING UE POLICY WHEN A UE IS ATTACHED IN AN EVOLVED PACKET SYSTEM

(71) Applicant: LENOVO (SINGAPORE) PTE. LTD., Singapore (SG)

(72) Inventors: Dimitrios Karampatsis, Ruislip (GB); Roozbeh Atarius, La Jolla, CA (US)

(73) Assignee: Lenovo (Singapore) Pte. Limited, Singapore (SG)

(21) Appl. No.: 19/480,316

(22) PCT Filed: Dec. 5, 2023
(86) PCT No.: PCT/EP2023/084393

§ 371 Date: Oct. 30, 2025

(30) Foreign Application Priority Data
Nov. 2, 2023 (GR) 20230100908

(51) Int. Cl. H04W 40/24; H04W 28/12; H04W 40/02

(52) U.S. Cl. CPC H04W 40/248; H04W 28/12; H04W 40/02

(57) ABSTRACT

Various aspects of the present disclosure relate to a first network function in a first mobile communication network, the first mobile communication network supporting connectivity in an Evolved Packet System (EPS) access that has an active policy association for a UE with a second network function, the first network function comprising: at least one memory; and at least one processor coupled with the at least one memory. The processor is configured to cause the first network function to: receive a first request comprising an active policy association request including a UE Policy Container; determine to trigger a UE Policy Delivery to the UE the determination based on the UE Policy Container received in the first request; and trigger a PDN-GW Bearer Modification without QoS update by sending a second request to a second network function wherein the second request is an Update Bearer Request that includes the UE Policy Container within a Protocol Configuration.

### TECHNICAL FIELD

The subject matter disclosed herein relates generally to the field of provisioning UE policy when a UE is attached in an Evolved Packet System. This document defines a first network function, a method performed by a first network function, a third network function, and a method performed by a third network function.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,”“at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Accordingly, there is provided a first network function in a first mobile communication network, the first mobile communication network supporting connectivity in an Evolved Packet System (EPS) access that has an active policy association for a UE with a second network function, the first network function comprising: at least one memory; and at least one processor coupled with the at least one memory. The processor is configured to cause the first network function to: receive a first request comprising an active policy association request including a UE Policy Container; determine to trigger a UE Policy Delivery to the UE the determination based on the UE Policy Container received in the first request; and trigger a PDN-GW Bearer Modification without QoS update by sending a second request to a second network function wherein the second request is an Update Bearer Request that includes the UE Policy Container within a Protocol Configuration.

There is further provided a method performed by a first network function in a first mobile communication network, the first mobile communication network supporting connectivity in an Evolved Packet System (EPS) access that has an active policy association for a UE with a second network function. The method comprises: receiving a first request comprising an active policy association request including a UE Policy Container; determining to trigger a UE Policy Delivery to the UE the determination based on the UE Policy Container received in the first request; and triggering a PDN-GW Bearer Modification without QoS update by sending a second request to a second network function wherein the second request is an Update Bearer Request that includes the UE Policy Container within a Protocol Configuration.

There is further provided a third network function in a first mobile communication network, the first mobile communication network supporting connectivity in an Evolved Packet System (EPS) access that has an active bearer association for a UE with a fourth network function, the third network function comprising: at least one memory; and at least one processor coupled with the at least one memory. The processor is configured to cause the third network function to: receive a third request from the active bearer association, the third request including a UE Policy Container, and where the third request is an Update Bearer request that has no QoS related information included; and send a fourth request towards the UE, where the fourth request is a Modify EPS Bearer Context request that includes the UE Policy Container within the Protocol Configuration Options of the Modify EPS Bearer Context request.

There is further provided a method performed by a third network function in a first mobile communication network, the first mobile communication network supporting connectivity in an Evolved Packet System (EPS) access that has an active bearer association for a UE with a fourth network function The method comprises: receiving a third request from the active bearer association, the third request including a UE Policy Container, and where the third request is an Update Bearer request that has no QoS related information included; and sending a fourth request towards the UE, where the fourth request is a Modify EPS Bearer Context request that includes the UE Policy Container within the Protocol Configuration Options of the Modify EPS Bearer Context request.

### BRIEF DESCRIPTION OF THE DRAWINGS

FIG. 1 illustrates an example of a wireless communications system in accordance with aspects of the present disclosure.

FIG. 2 illustrates a procedure to indicate support of URSP provisioning when a UE is attached in EPS.

FIG. 3 illustrates a procedure that includes triggering PDN-GW initiated bearer modification without QoS update procedure.

FIG. 4 illustrates an example of a user equipment (UE) in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by a NE in accordance with aspects of the present disclosure.

FIG. 8 illustrates a flowchart of a further method performed by a NE in accordance with aspects of the present disclosure.

### DETAILED DESCRIPTION

In Release 18, solutions were defined to allow the PCF to provide URSP rules to the UE when the UE is attached in EPS. However, there is a missing procedure on how the UE policy container received from the PCF may be conveyed to the UE.

The first network function defined herein, which may be the SMF+PGW-C, conveys the UE policy container received from the PCF to the UE. There is defined herein a method and apparatus that includes details on how the SMF+PGW-C encodes the UE policy container within an Update Bearer request message.

Aspects of the present disclosure are described in the context of a wireless communications system.

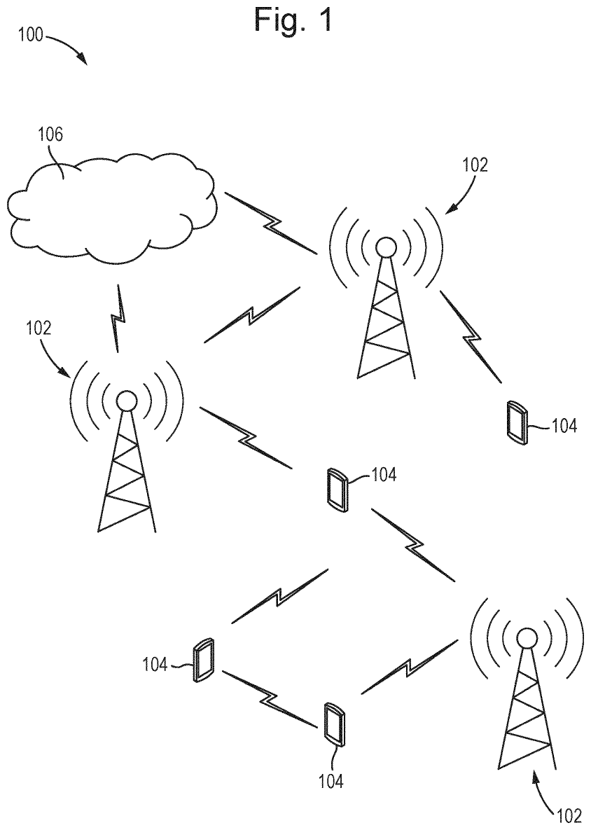

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. # Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Since Release 15 of the 3GPP specifications onwards, UE route selection policy (URSP) rules have been defined to allow a UE to determine how to route application traffic via a wireless communication network. The UE may access the wireless communication network either via 3GPP access or via non-3GPP access. The non-3GPP access may be via an untrusted or trusted WLAN access or the UE may route the traffic non-seamlessly bypassing the mobile communication network via a WLAN connection. The URSP rules and the procedures for the UE to apply URSP rules are described in 3GPP TS 23.502 and 3GPP TS 23.503 (URSP rules definitions and procedures are included from version 15.0.0 onwards of 23.502 and 23.503).

A URSP rule contains a Traffic Descriptor (TD) that allows the UE to determine if the URSP rule matches application traffic. Traffic Descriptors include: Application Descriptors (OSID/OSAppID), IP flow descriptors e.g. target address of application traffic, a requested DNN by the application, or a connection capability requested by an application (e.g. an IMS connection).

Each URSP rule contains a Route Selection Descriptor (RSD) that tells the UE how to route the PDU session. The RSD includes one or more of the following: SSC Mode Selection, Network Slice Selection, DNN Selection, PDU Session Type Selection, Non-Seamless Offload indication, and/or Access Type preference.

The UE routes the traffic that meets the TD definition via the PDU session that matches the RSD components. The UE may route the traffic via 3GPP or non-3GPP access.

URSP rules are only provided to a UE from the PCF of the Home Public Land Mobile Network (HPLMN), i.e. H-PCF. Up to Release 17 of the 3GPP specifications, the PCF provides URSP rules to a UE when the UE is registered in 5GS. The PCF includes URSP rules in UE policy sections that are sent to UE by invoking a UE Configuration Update procedure for transparent UE Policy delivery as currently described in clause 4.2.4.3 of 3GPP TS 23.502 v18.3.0 “Procedures for the 5G System (5GS)”, September 2023.

In Release 18 of the 3GPP specifications, solutions were defined to allow the PCF to provide URSP rules to the UE when the UE is attached in Evolved Packet System (EPS).

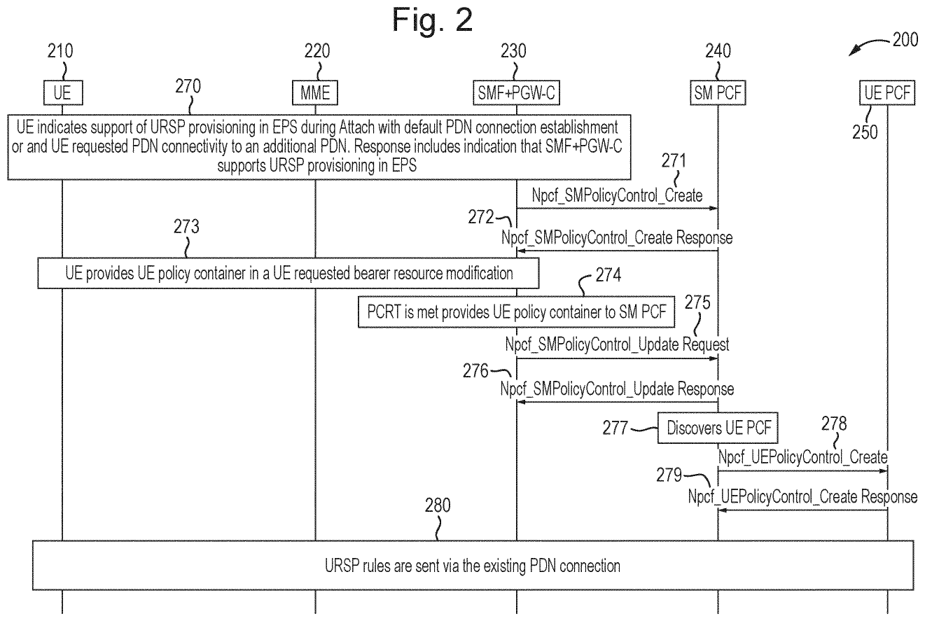

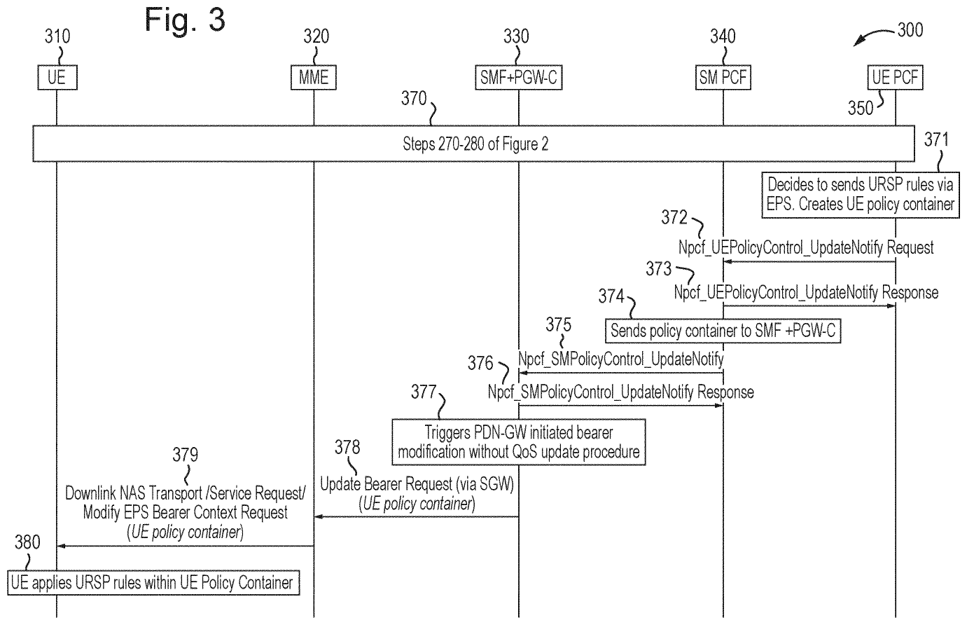

FIG. 2 illustrates a procedure 200 to indicate support of URSP provisioning when a UE is attached in EPS. The procedure 200 is illustrated as being performed by a User Equipment (UE) 210, an Mobility Management Entity (MME) 220, an SMF+PGW-C 230, a Session management (SM) Policy Control Function (PCF) 240, and a UE PCF 250.

The SMF implements the 3GPP recommendations for interworking of Evolved Packet System (EPS) and 5G Core Network (5GC). A UE capable of supporting both 4G and 5G NAS connects to the Evolved Terrestrial Radio Access Network (E-UTRAN) and the 5GC network. An SMF with the EPS interworking capability acts as a PGW-C+SMF and uses the S5 or S8 interface with S-GW to receive the 4G Session Creation Request. All the other interfaces involved in the 4G Session Creation (for example, Gx, Gy, Gz, and so on) are replaced by the corresponding 5GC Service Based Interfaces (for example, Npcf and Nchf).

In general, after a PDU session is created on the PGW-C+SMF with E-UTRAN, Mobility Management Entity (MME) and Serving Gateway (S-GW), the UE can hand over E-UTRAN to 5G New Radio (NR) and vice-versa. The SMF currently supports interworking with EPS using the N26 interface. This interface is an inter-CN interface between the MME and 5GS AMF to enable interworking between Evolved Packet Core (EPC) and the NG core networks. Support of N26 interface in the network is optional for interworking. N26 supports a subset of the functionalities over S10 interface to enable interworking. The UE may use EPC NAS or 5GC NAS procedures depending on the core network by which it is served.

At 270, the UE 210 indicates support of URSP provisioning in EPS during attach with default PDN connection establishment or any UE requested PDN connectivity to an additional PDN. A response from SMF+PGW-C 230 includes an indication that SMF+PGW-C 230 supports URSP provisioning in EPS. When the UE 210 attaches in EPS the UE 210 includes support of URSP provisioning in EPS within PCO (Protocol Configuration Option) within the PDN connectivity request included in the Attach Request. The SMF+PGW-C 230 includes in the response (which is a PDN connectivity response) that URSP provisioning in EPS is also supported. The UE 210 may also send a PDN connectivity request with the URSP provisioning in EPS support indication after attach is completed if the Attach is requested with no PDN connection. The SMF+PGW-C 230 may include in the response that URSP provisioning in EPS is also supported.

At 271, SMF+PGW-C 230 sends an Npcf_SMPolicyControl_Create message to the SM PCF 240. The Npcf_SMPolicyControl_Create message includes access type: EPS. Thus, the SMF+PGW-C 230 establishes an SM policy association by sending an Npcf_SMPolicyControl Create Request with the PCF managing the PDU sessions (SM PCF) and indicates the access type is EPS.

At 272, the SM PCF 240 sends an Npcf_SMPolicyControl_Create Response to the SMF+PGW-C 230. The Npcf_SMPolicyControl_Create Response includes PCRTs for SM policy control. The SM PCF 240 thus acknowledges the response and includes Policy Control Request Triggers (PCRT) that are sent to the SMF+PGW-C 230. The PCRT are used by the SMF+PGW-C 230 to determine when to send an SM Policy Association update.

At 273, the UE 210 UE provides a UE policy container in a UE requested bearer resource modification. The UE includes a UE policy container with a list of PSIs stored in the UE within a PCO within a UE requested bearer resource modification request.

At 274, the PCRT trigger is met and the SMF+PGW-C updates the SM policy association. When the PCRT trigger is met, the SMF+PGW-C 230 provides a UE policy container to SM PCF 240.

At 275, an Npcf_SMPolicyControl_Update Request is sent by the SMF+PGW-C 230 to the SM PCF 240. The Npcf_SMPolicyControl_Update Request includes the UE policy container. The SMF+PGW-C thus sends an SM Policy Association update by sending an Npcf_SMPolicyControl_Update Request including the UE policy container received from the UE.

At 276, the SM PCF acknowledges the request with an Npcf_SMPolicyControl_Update Response.

At 277, the SM PCF 240 determines that a PCF managing the UE policy (UE PCF 250) needs to be discovered and discovers the UE PCF via the Binding Support Function (BSF).

At 278, the SM PCF 240 sends an Npcf_UEPolicyControl_Create message to the UE PCF 250. The Npcf_UEPolicyControl_Create message comprises access type EPS, and a UE policy container. The SM PCF 240 sends a UE Policy Control request to the UE PCF including the UE Policy Container in the Npcf_UEPolicyControl Create request.

At 279, the UE PCF sends an Npcf_UEPolicyControl_Create Response message to the SM PCF 240. The Npcf_UEPolicyControl_Create Response message comprises a PCRT for UE policy control. The UE PCF 250 thus acknowledges the UE Policy Control request, including in the acknowledging response policy control request triggers to the SM PCF 240.

At 280, when the UE PCF needs to send URSP rules the UE PCF sends them to the UE via the existing PDN connection.

There are presented herein additional enhancements to the above procedure to solve the issue of how the UE should receive a policy container within an existing PDN connection.

The solution described herein requires that the SMF+PGW-C sends URSP rules to the UE by invoking a PDN-GW initiated bearer modification without QoS update procedure. Clause 5.4.3 of 3GPP TS 23.401 18.3.0 “GPRS enhancements for E-UTRAN access” (September 2023) describes PDN GW initiated bearer modification without bearer QoS update. The solution described herein comprises the SMF+PGW-C including a UE Policy Container within PCO in the Update Bearer Request to the SGW; and that the SGW sends the UE Policy Container within PCO in the Update Bearer Request to the MME. The MME includes the UE Policy Container within a PCO in the service request message towards the UE.

FIG. 3 illustrates a procedure 300 that includes triggering PDN-GW initiated bearer modification without QoS update procedure. The procedure 300 is illustrated as being performed by a User Equipment (UE) 310, a Mobility Management Entity (MME) 320, an SMF+PGW-C 330, a Session management (SM) Policy Control Function (PCF) 340, and a UE PCF 350.

At 370, UE attaches in EPS and provides support of URSP provisioning in EPS as described in steps 270 to 280 of FIG. 2.

At 371, the UE PCF 350 decides to send updated URSP rules to the UE while the UE is attached in EPS. The UE PCF 350 includes the URSP rules in a UE Policy Container. The UE PCF 350 creates UE policy container. The UE PCF 350 knows that the UE 310 is in EPS as there is an existing UE Policy Control association with an SM PCF 340.

At 372, the UE PCF 350 includes the UE Policy Container within the existing Policy Control Association to the SM PCF 340 within an Npcf_UEPolicyControlUpdate Notify service operation.

At 373, the SM PCF 340 acknowledges the request with a Npcf_UEPolicyControl_UpdateNotify Response message.

At 374, the SM PCF 340 sends the UE Policy Container to the SMF+PGW-C 330.

At 375, the SM PCF 340 includes the UE Policy Container within the existing SM Policy Association to the SMF+PGW-C 330 within an Npcf_SMPolicyControlUpdate Notify service operation.

At 376, the SMF+PGW-C 330 acknowledges the request with a Npcf_SMPolicyControl_UpdateNotify Response message.

At 377, the SMF+PGW-C 330 triggers a PDN-GW initiated bearer modification without QoS update procedure to send the UE policy container to the UE 310.

At 378, the SMF+PGW-C 330 sends the UE Policy Container within PCO to the MME 320 via the SGW within an Update Bearer Request (step between SGW and MME is not shown in FIG. 3 for simplicity). The SMF+PGW-C 330 uses Update Bearer Request for this purpose without including the Bearer Level QoS information element or modifying the Bearer Level QoS information element of Bearer Context within Update Bearer Request, see 3GPP TS 29.274 v18.4.0 “3GPP Evolved Packet System (EPS); Evolved General Packet Radio Service (GPRS) Tunnelling Protocol for Control plane (GTPv2-C); Stage 3” (September 2023). The SMF+PGW-C 330 includes the URSP rules in the container with the container identifier “UE policy container with the length of two octets” and include in the ePCO IE of the Update Bearer Request.

At 379, Upon receipt of the Update Bearer Request, the MME initiates the EPS bearer context modification procedure by using MODIFY EPS BEARER CONTEXT REQUEST message without any QoS or without change of the QoS, see 3GPP TS 24.301 v 18.4.0 “Non-Access-Stratum (NAS) protocol for Evolved Packet System (EPS); Stage 3” (September 2023). The MME 320 includes the ePCO IE including the container with the container identifier “UE policy container with the length of two octets” containing the URSP rules in the MODIFY EPS BEARER CONTEXT REQUEST message towards the UE. The MME 320 sends the MODIFY EPS BEARER CONTEXT REQUEST message towards the UE and starts the timer T3486, and enters the state BEARER CONTEXT MODIFY PENDING.

At 380, the UE 310 applies the URSP rules as described in 3GPP TS 23.503 by forwarding the container with the container identifier “UE policy container with the length of two octets” to the UE policy delivery service, see 3GPP TS 24.501 v18.4.0 “Non-Access-Stratum (NAS) protocol for 5G System (5GS); Stage 3” (September 2023). The UE 310s send the MODIFY EPS BEARER CONTEXT ACCEPT message towards the MME 320.

Accordingly, there is provided a first network function in a first mobile communication network, the first mobile communication network supporting connectivity in an Evolved Packet System (EPS) access that has an active policy association for a UE with a second network function, the first network function comprising: at least one memory; and at least one processor coupled with the at least one memory. The processor is configured to cause the first network function to: receive a first request comprising an active policy association request including a UE Policy Container; determine to trigger a UE Policy Delivery to the UE the determination based on the UE Policy Container received in the first request; and trigger a PDN-GW Bearer Modification without QoS update by sending a second request to a second network function wherein the second request is an Update Bearer Request that includes the UE Policy Container within a Protocol Configuration.

In Release 18, solutions were defined to allow the PCF to provide URSP rules to the UE when the UE is attached in EPS. However, there is a missing procedure on how the UE policy container received from the PCF may be conveyed to the UE. The first network function defined herein, which may be the SMF+PGW-C, conveys the UE policy container received from the PCF to the UE. There is defined herein a method and apparatus that includes details on how the SMF+PGW-C encodes the UE policy container within an Update Bearer request message.

The first network function may be an SMF+PGW-C. The SMF implements the 3GPP recommendations for interworking of Evolved Packet System (EPS) and 5G Core Network (5GC). A UE capable of supporting both 4G and 5G NAS connects to the Evolved Terrestrial Radio Access Network (E-UTRAN) and the 5GC network. An SMF with the EPS interworking capability acts as a PGW-C+SMF and uses the S5 or S8 interface with S-GW to receive the 4G Session Creation Request. All the other interfaces involved in the 4G Session Creation (for example, Gx, Gy, Gz, and so on) are replaced by the corresponding 5GC Service Based Interfaces (for example, Npcf and Nchf).

After a PDU session is created on the PGW-C+SMF with E-UTRAN, Mobility Management Entity (MME) and Serving Gateway (S-GW), the UE can hand over E-UTRAN to 5G New Radio (NR) and vice-versa. The SMF currently supports interworking with EPS using the N26 interface. This interface is an inter-CN interface between the MME and 5GS AMF to enable interworking between Evolved Packet Core (EPC) and the NG core networks. Support of N26 interface in the network is optional for interworking. N26 supports a subset of the functionalities over S10 interface to enable interworking. The UE may use EPC NAS or 5GC NAS procedures depending on the core network by which it is served.

The second network function may be an SM PCF. The second network function may be a UE PCF.

The UE policy container may include at least one UE Route Selection Policy Rule (URSP).

The second request may include the at least one URSP rule.

The Protocol Configuration may comprise an extended Protocol Configuration Options (ePCO) information element.

The extended configuration options information element may include a container identifier that indicates the UE Policy Container is included within the extended configuration options information element.

The container identifier may indicate that the UE Policy Container has a length of two octets.

The second request may include the container identifier in the Extended Protocol Configuration Options (ePCO) information element of the Update Bearer Request.

The second request may comprise an Update Bearer Request that neither includes the Bearer Level QoS information element or modifies the Bearer Level QoS information element of a Bearer Context.

There is further provided a method performed by a first network function in a first mobile communication network, the first mobile communication network supporting connectivity in an Evolved Packet System (EPS) access that has an active policy association for a UE with a second network function. The method comprises: receiving a first request comprising an active policy association request including a UE Policy Container; determining to trigger a UE Policy Delivery to the UE the determination based on the UE Policy Container received in the first request; and triggering a PDN-GW Bearer Modification without QoS update by sending a second request to a second network function wherein the second request is an Update Bearer Request that includes the UE Policy Container within a Protocol Configuration.

In Release 18, solutions were defined to allow the PCF to provide URSP rules to the UE when the UE is attached in EPS. However, there is a missing procedure on how the UE policy container received from the PCF may be conveyed to the UE. The first network function defined herein, which may be the SMF+PGW-C, conveys the UE policy container received from the PCF to the UE. There is defined herein a method and apparatus that includes details on how the SMF+PGW-C encodes the UE policy container within an Update Bearer request message.

The first network function may be an SMF+PGW-C. The SMF implements the 3GPP recommendations for interworking of Evolved Packet System (EPS) and 5G Core Network (5GC). A UE capable of supporting both 4G and 5G NAS connects to the Evolved Terrestrial Radio Access Network (E-UTRAN) and the 5GC network. An SMF with the EPS interworking capability acts as a PGW-C+SMF and uses the S5 or S8 interface with S-GW to receive the 4G Session Creation Request. All the other interfaces involved in the 4G Session Creation (for example, Gx, Gy, Gz, and so on) are replaced by the corresponding 5GC Service Based Interfaces (for example, Npcf and Nchf).

After a PDU session is created on the PGW-C+SMF with E-UTRAN, Mobility Management Entity (MME) and Serving Gateway (S-GW), the UE can hand over E-UTRAN to 5G New Radio (NR) and vice-versa. The SMF currently supports interworking with EPS using the N26 interface. This interface is an inter-CN interface between the MME and 5GS AMF to enable interworking between Evolved Packet Core (EPC) and the NG core networks. Support of N26 interface in the network is optional for interworking. N26 supports a subset of the functionalities over S10 interface to enable interworking. The UE may use EPC NAS or 5GC NAS procedures depending on the core network by which it is served.

The second network function may be an SM PCF. The second network function may be a UE PCF.

The UE policy container may include at least one UE Route Selection Policy Rule (URSP).

The second request may include the at least one URSP rule.

The Protocol Configuration may comprise an extended Protocol Configuration Options (ePCO) information element.

The extended configuration options information element may include a container identifier that indicates the UE Policy Container is included within the extended configuration options information element.

The container identifier may indicate that the UE Policy Container has a length of two octets.

The second request may include the container identifier in the Extended Protocol Configuration Options (ePCO) information element of the Update Bearer Request.

The second request may comprise an Update Bearer Request that neither includes the Bearer Level QoS information element or modifies the Bearer Level QoS information element of a Bearer Context.

There is further provided a processor for wireless communication, the processor comprising at least one controller coupled with at least one memory and configured to cause the processor to: receive a first request comprising an active policy association request including a UE Policy Container; determine to trigger a UE Policy Delivery to the UE the determination based on the UE Policy Container received in the first request; and trigger a PDN-GW Bearer Modification without QoS update by sending a second request to a second network function wherein the second request is an Update Bearer Request that includes the UE Policy Container within a Protocol Configuration.

There is further provided a third network function in a first mobile communication network, the first mobile communication network supporting connectivity in an Evolved Packet System (EPS) access that has an active bearer association for a UE with a fourth network function, the third network function comprising: at least one memory; and at least one processor coupled with the at least one memory. The processor is configured to cause the third network function to: receive a third request from the active bearer association, the third request including a UE Policy Container, and where the third request is an Update Bearer request that has no QoS related information included; and send a fourth request towards the UE, where the fourth request is a Modify EPS Bearer Context request that includes the UE Policy Container within the Protocol Configuration Options of the Modify EPS Bearer Context request.

In Release 18, solutions were defined to allow the PCF to provide URSP rules to the UE when the UE is attached in EPS. However, there is a missing procedure on how the UE policy container received from the PCF may be conveyed to the UE. The third network function defined herein, which may be the Mobility Management Entity (MME), conveys the UE policy container received from the PCF to the UE. There is defined herein a method and apparatus that includes details on how the MME encodes the UE policy container within a Modify EPS Bearer Context request.

The third network function may be a Mobility Management Entity (MME). The fourth network function may be a Service Gateway function (SGW). The QoS related information absent from the Update Bearer request may include a Bearer Level QoS information element.

The UE policy container may include at least one UE Route Selection Policy Rule (URSP).

The fourth request may include the at least one URSP rule.

The Protocol Configuration may comprise an extended Protocol Configuration Options (ePCO) information element.

The extended configuration options information element may include a container identifier that indicates a UE Policy Container is included within the extended configuration options information element.

The container identifier may indicate that the UE Policy Container has a length of two octets.

The fourth request includes the container identifier in the Extended Protocol Configuration Options (ePCO) information element of the Update Bearer Request.

There is further provided a method performed by a third network function in a first mobile communication network, the first mobile communication network supporting connectivity in an Evolved Packet System (EPS) access that has an active bearer association for a UE with a fourth network function The method comprises: receiving a third request from the active bearer association, the third request including a UE Policy Container, and where the third request is an Update Bearer request that has no QoS related information included; and sending a fourth request towards the UE, where the fourth request is a Modify EPS Bearer Context request that includes the UE Policy Container within the Protocol Configuration Options of the Modify EPS Bearer Context request.

In Release 18, solutions were defined to allow the PCF to provide URSP rules to the UE when the UE is attached in EPS. However, there is a missing procedure on how the UE policy container received from the PCF may be conveyed to the UE. The third network function defined herein, which may be the Mobility Management Entity (MME), conveys the UE policy container received from the PCF to the UE. There is defined herein a method and apparatus that includes details on how the MME encodes the UE policy container within a Modify EPS Bearer Context request.

The third network function may be a Mobility Management Entity (MME). The fourth network function may be a Service Gateway function (SGW). The QoS related information absent from the Update Bearer request may include a Bearer Level QoS information element.

The UE policy container may include at least one UE Route Selection Policy Rule (URSP).

The fourth request may include the at least one URSP rule.

The Protocol Configuration may comprise an extended Protocol Configuration Options (ePCO) information element.

The extended configuration options information element may include a container identifier that indicates a UE Policy Container is included within the extended configuration options information element.

The container identifier may indicate that the UE Policy Container has a length of two octets.

The fourth request includes the container identifier in the Extended Protocol Configuration Options (ePCO) information element of the Update Bearer Request.

There is further provided a processor for wireless communication, the processor comprising at least one controller coupled with at least one memory and configured to cause the processor to: receive a third request from the active bearer association, the third request including a UE Policy Container, and where the third request is an Update Bearer request that has no QoS related information included; and send a fourth request towards the UE, where the fourth request is a Modify EPS Bearer Context request that includes the UE Policy Container within the Protocol Configuration Options of the Modify EPS Bearer Context request.

The 3GPP specifications are missing a procedure on how the SMF+PGW-C should convey the UE policy container received from the PCF to the UE. As described herein, an existing procedure may be re-used where the SMF+PGW-C triggers a PDN-GW bearer initiated procedure without QoS update procedure to convey the UE policy container to the UE. The SMF+PGW-C includes the UE Policy Container in the Update Bearer Request message without including any QoS information and the MME including the UE Policy Container within the Modify EPS Bearer Context Request message where the MME also does not include any QoS information. There is thus described the delivery of UE policies to the UE when the UE is attached in EPS.

Accordingly, there is provided a first network function (SMF+PGW-C) in a first mobile communication network supporting connectivity in an EPS access that has an active policy association for a UE with a second network function (PCF), and arranged to: receive a first request from the active policy association a request including a UE Policy Container, determine based on the UE Policy Container to trigger UE Policy Delivery to the UE, trigger an PDN-GW Bearer Modification without QoS update by sending a second request to a second network function wherein the second request is an Update Bearer Request that includes the UE Policy Container within Protocol Configuration Options.

The UE policy container may include UE Route Selection Policy Rules.

The second request may not include the Bearer Level QoS information element or modifying the Bearer Level QoS information element of Bearer Context within Update Bearer Request.

The second request may include the URSP rules in the UE Policy container with the container identifier “UE policy container with the length of two octets” and may include in the ePCO IE of the Update Bearer Request.

There is further provided a third network function (MME) in a first mobile communication network supporting connectivity in an EPS access that has an active bearer association for a UE with a fourth network function (SGW), and arranged to: receive a third request from the active bearer association a request including a UE Policy Container where the first request is an Update Bearer request has no QoS related information included, and send a fourth request towards the UE where the fourth request is a Modify EPS Bearer Context request that includes the UE Policy Container within Protocol Configuration Options.

The UE policy container may include UE Route Selection Policy Rules.

The fourth request may include the URSP rules in the UE Policy container within the ePCO IE including the container with the container identifier “UE policy container with the length of two octets”.

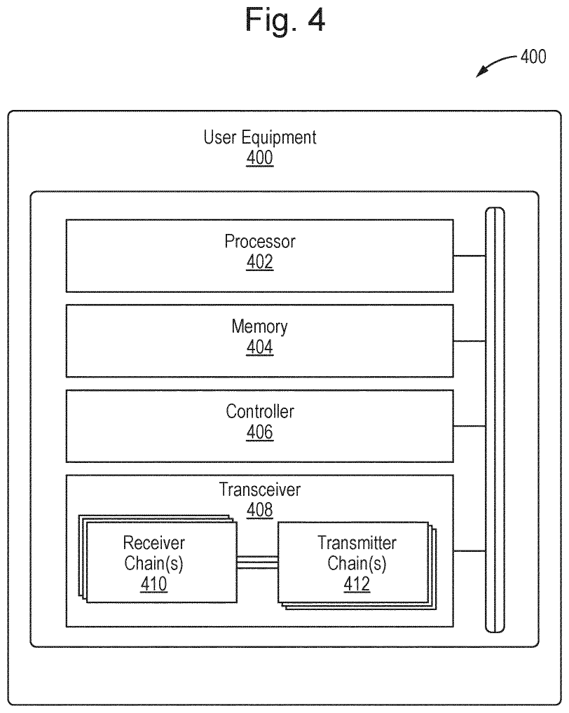

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving a first request comprising an active policy association request including a UE Policy Container; determining to trigger a UE Policy Delivery to the UE the determination based on the UE Policy Container received in the first request; and triggering a PDN-GW Bearer Modification without QoS update by sending a second request to a second network function wherein the second request is an Update Bearer Request that includes the UE Policy Container within a Protocol Configuration. Alternatively, the NE 600 may be configured to support a means for receiving a third request from the active bearer association, the third request including a UE Policy Container, and where the third request is an Update Bearer request that has no QoS related information included; and sending a fourth request towards the UE, where the fourth request is a Modify EPS Bearer Context request that includes the UE Policy Container within the Protocol Configuration Options of the Modify EPS Bearer Context request.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

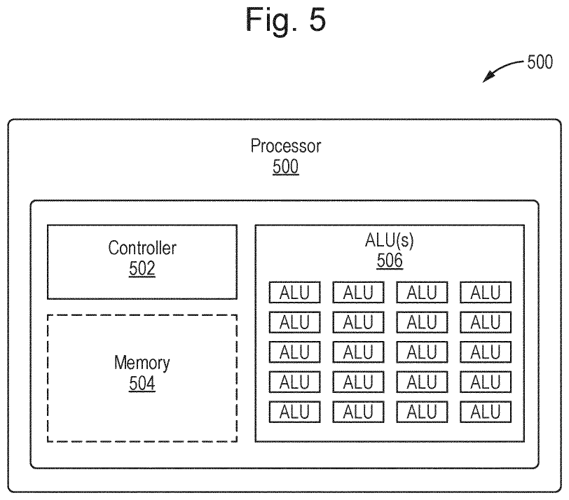

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signalling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for receiving a first request comprising an active policy association request including a UE Policy Container; determining to trigger a UE Policy Delivery to the UE the determination based on the UE Policy Container received in the first request; and triggering a PDN-GW Bearer Modification without QoS update by sending a second request to a second network function wherein the second request is an Update Bearer Request that includes the UE Policy Container within a Protocol Configuration. Alternatively, the NE 600 may be configured to support a means for receiving a third request from the active bearer association, the third request including a UE Policy Container, and where the third request is an Update Bearer request that has no QoS related information included; and sending a fourth request towards the UE, where the fourth request is a Modify EPS Bearer Context request that includes the UE Policy Container within the Protocol Configuration Options of the Modify EPS Bearer Context request.

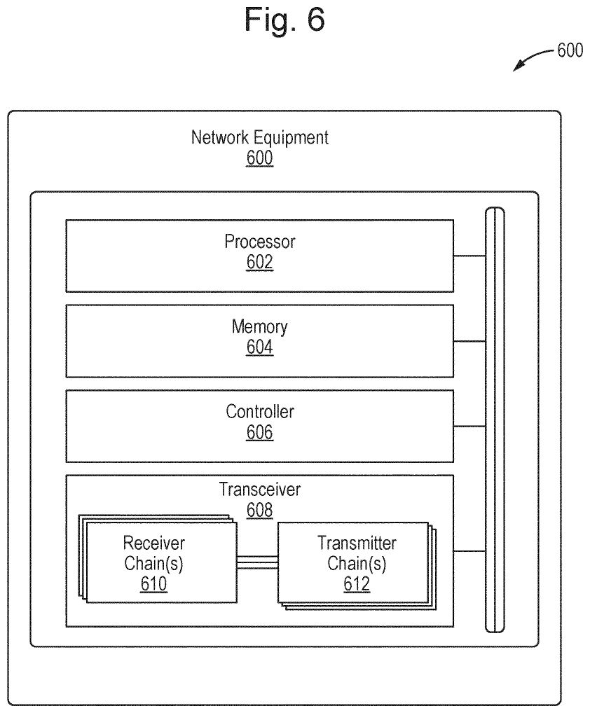

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for receiving a first request comprising an active policy association request including a UE Policy Container; determining to trigger a UE Policy Delivery to the UE the determination based on the UE Policy Container received in the first request; and triggering a PDN-GW Bearer Modification without QoS update by sending a second request to a second network function wherein the second request is an Update Bearer Request that includes the UE Policy Container within a Protocol Configuration. Alternatively, the NE 600 may be configured to support a means for receiving a third request from the active bearer association, the third request including a UE Policy Container, and where the third request is an Update Bearer request that has no QoS related information included; and sending a fourth request towards the UE, where the fourth request is a Modify EPS Bearer Context request that includes the UE Policy Container within the Protocol Configuration Options of the Modify EPS Bearer Context request.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

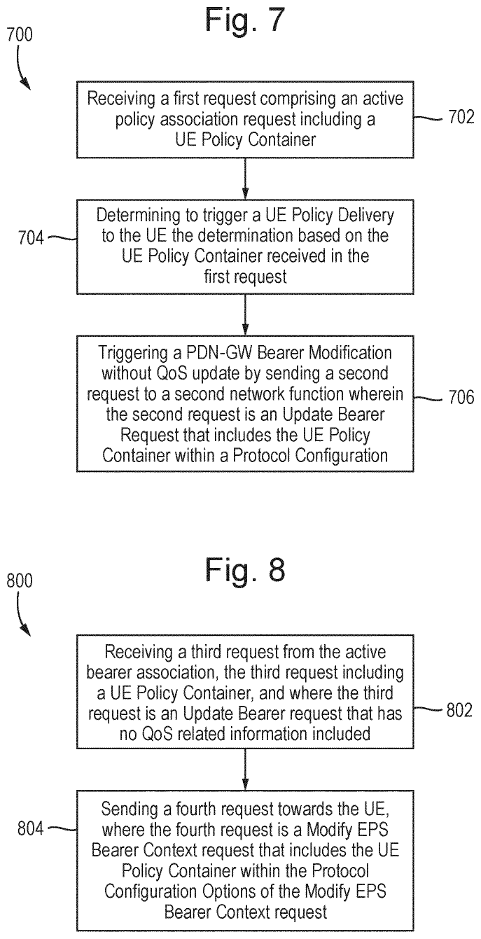

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions.

At 702, the method 700 may include receiving a first request comprising an active policy association request including a UE Policy Container. The operations of 702 may be performed in accordance with examples as described herein. In some implementations, aspects of the operations of 702 may be performed by a NE as described with reference to FIG. 6.

At 704, the method 700 may include determining to trigger a UE Policy Delivery to the UE the determination based on the UE Policy Container received in the first request. The operations of 704 may be performed in accordance with examples as described herein. In some implementations, aspects of the operations of 704 may be performed by a NE as described with reference to FIG. 6.

At 706, the method 700 may include triggering a PDN-GW Bearer Modification without QoS update by sending a second request to a second network function wherein the second request is an Update Bearer Request that includes the UE Policy Container within a Protocol Configuration. The operations of 706 may be performed in accordance with examples as described herein. In some implementations, aspects of the operations of 706 may be performed a NE as described with reference to FIG. 6.

It should be noted that the method 700 described herein describes a possible implementation, and that the operations and the steps may be rearranged or otherwise modified and that other implementations are possible.

FIG. 8 illustrates a flowchart of a method 800 in accordance with aspects of the present disclosure. The operations of the method 800 may be implemented by a NE as described herein. In some implementations, the NE may execute a set of instructions to control the function elements of the NE to perform the described functions.

At 802, the method 800 may include receiving a third request from the active bearer association, the third request including a UE Policy Container, and where the third request is an Update Bearer request that has no QoS related information included. The operations of 802 may be performed in accordance with examples as described herein. In some implementations, aspects of the operations of 802 may be performed by a NE as described with reference to FIG. 6.

At 804, the method 800 may include sending a fourth request towards the UE, where the fourth request is a Modify EPS Bearer Context request that includes the UE Policy Container within the Protocol Configuration Options of the Modify EPS Bearer Context request. The operations of 804 may be performed in accordance with examples as described herein. In some implementations, aspects of the operations of 804 may be performed by a NE as described with reference to FIG. 6.

It should be noted that the method 800 described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

The following abbreviations are relevant in the field addressed by this document: URSP, UE Routing Selection Policy; PCF, Policy and Charging Function; UE, User Equipment; NEF, Network Exposure Function; UDR, Unified Data Repository; PSI, Policy Section Identifier; RSD, Route Selection Descriptor; PCO, Protocol Configuration Option; and ePCO, Extended Protocol Configuration Options.

1. A first network function in a mobile communication network, the mobile communication network supporting connectivity in an evolved packet system (EPS) access that has an active policy association for a user equipment (UE) with a second network function, the first network function comprising:
at least one memory; and
at least one processor coupled with the at least one memory and configured to cause the first network function to:
receive an active policy association request including a UE policy container;
determine to trigger a UE policy delivery to the UE based at least in part on the UE policy container; and
trigger a packet data network-gateway (PDN-GW) bearer modification without a quality of service (QoS) update by transmitting an update bearer request message to a third network function, wherein the update bearer request message includes the UE policy container within a protocol configuration.

2. The first network function of claim 1, wherein the UE policy container includes at least one UE route selection policy rule (URSP).

3. The first network function of claim 2, wherein the update bearer request message includes the at least one URSP rule.

4. The first network function of claim 1, wherein the protocol configuration comprises an extended protocol configuration options (ePCO) information element.

5. The first network function of claim 4, wherein the ePCO information element includes a container identifier that indicates the UE policy container is included within the ePCO information element.

6. The first network function of claim 5, wherein the container identifier indicates that the UE policy container has a length of two octets.

7. The first network function of claim 5, wherein the update bearer request message includes the container identifier in the ePCO information element of the update bearer request message.

8. The first network function of claim 1, wherein the update bearer request message neither includes a bearer level QoS information element or modifies the bearer level QoS information element of a bearer context.

9. A method performed by a first network function in a first mobile communication network, the mobile communication network supporting connectivity in an evolved packet system (EPS) access that has an active policy association for a user equipment (UE) with a second network function, the method comprising:
receiving an active policy association request including a UE policy container;
determining to trigger a UE policy delivery to the UE based at least in part on the UE policy container; and
triggering a packet data network-gateway (PDN-GW) bearer modification without a quality of service (QoS) update by transmitting an update bearer request message to a third network function, wherein the update bearer request message includes the UE policy container within a protocol configuration.

10. The method of claim 9, wherein the UE policy container includes at least one UE route selection policy rule (URSP).

11. The method of claim 10, wherein the update bearer request message includes the at least one URSP rule.

12. The method of claim 9, wherein the protocol configuration comprises an extended protocol configuration options (ePCO) information element.

13. A third network function in a mobile communication network, the mobile communication network supporting connectivity in an evolved packet system (EPS) access that has an active bearer association for a user equipment (UE) with a fourth network function, the third network function comprising:
at least one memory; and
at least one processor coupled with the at least one memory and configured to cause the third network function to:
receive an update bearer request message that has no quality of service (QoS) related information included, the update bearer request message including a UE policy container; and
transmit, to the UE, a modify EPS bearer context request that includes the UE policy container within protocol configuration options of the modify EPS bearer context request.

14. The third network function of claim 13, wherein the UE policy container includes at least one UE route selection policy rule (URSP).

15. The third network function of claim 14, wherein the modify EPS bearer context request includes the at least one URSP rule.

16-19. (canceled)

20. A method performed by a third network function in a mobile communication network, the mobile communication network supporting connectivity in an evolved packet system (EPS) access that has an active bearer association for a user equipment (UE) with a fourth network function, the method comprising:
receiving an update bearer request message that has no quality of service (QoS) related information included, the update bearer request message including a UE policy container; and
transmitting, to the UE, a modify EPS bearer context request that includes the UE policy container within protocol configuration options of the modify EPS bearer context request.

21. The method of claim 12, wherein the ePCO information element includes a container identifier that indicates the UE policy container is included within the ePCO information element.

22. The method of claim 21, wherein the container identifier indicates that the UE policy container has a length of two octets.

23. The method of claim 21, wherein the update bearer request message includes the container identifier in the ePCO information element of the update bearer request message.

24. The method of claim 9, wherein the update bearer request message neither includes a bearer level QoS information element or modifies the bearer level QoS information element of a bearer context.
